(19) United States
(12) Patent Application Publication
(10) Pub. No.: US 2026/0243335 A1
(43) Pub. Date: Aug. 20, 2026

(54) MAGNETIZED LINEAR ACTUATORS AND ACTUATOR ASSEMBLIES USING THE SAME

(71) Applicant: SOUTHCO, INC., Concordville, PA (US)

(72) Inventor: Douglas John Griesbach, Concordville, PA (US)

(73) Assignee: SOUTHCO, INC., Concordville, PA (US)

(21) Appl. No.: 19/160,549

(22) PCT Filed: Feb. 29, 2024
(86) PCT No.: PCT/US2024/017830

§ 371 Date: Aug. 28, 2025

Related U.S. Application Data
(60) Provisional application No. 63/449,744, filed on Mar. 3, 2023.

(51) Int. Cl. F16H 25/20; E05B 47/00; H02K 7/116

(52) U.S. Cl. CPC F16H 25/2015; E05B 47/0012; E05B 47/004; F16H 25/2021; H02K 7/1166; E05B 2047/0016; E05B 2047/0017; E05B 2047/0023; E05B 2047/0036; F16H 2025/2075

(57) ABSTRACT

A magnetized linear actuator includes a rod housing and a motor having a shaft. The actuator has a worm gear, which defines a threaded surface and a non-threaded surface, that rotates in response to the shaft. An elongated rod has a rod engagement surface engageably coupled directly or indirectly to the worm gear. A plurality of magnets, which is directly or indirectly mounted on at least one of the rod and rod housing, controls translation of the rod between a retracted position and an extended position. To be translated to the extended position and retracted position, the rod is urged by a magnetic force of the plurality of magnets to be in an engaged position with the worm gear, thereby causing or permitting the rod to translate in response to rotation of the worm gear along a first rotational direction and a second rotational direction, respectively.

### CROSS-REFERENCE TO RELATED APPLICATION

This application claims priority to U.S. Provisional Application No. 63/449,744, filed Mar. 3, 2023, the contents of which are incorporated herein by reference in their entirety for all purposes.

### FIELD OF THE INVENTION

This invention generally relates to magnetized linear actuators and actuator assemblies that can include magnetized linear actuators.

### BACKGROUND OF THE INVENTION

A linear actuator is designed to convert rotational motion from a motor into linear motion, such as for providing the force necessary to move and position an object or a piece of equipment. Conventional applications for linear actuators include straight push/pull movements, as well as lifting and tilting movements. There remains a need, however, for improvements of linear actuators in terms of at least one of performance, cost, operability, and functionality.

### SUMMARY OF THE INVENTION

Aspects of the invention provide for magnetized linear actuators and actuator assemblies that can include magnetized linear actuators.

According to one aspect of the invention, a magnetized linear actuator is disclosed. The magnetized linear actuator includes a rod housing and a motor having a shaft. The magnetized linear actuator also includes a worm gear disposed within the rod housing and defining a threaded surface and a non-threaded surface. The worm gear is configured to be engageably coupled directly or indirectly to the shaft and the worm gear rotates about a rotation axis in response to motion of the shaft. The magnetized linear actuator also includes an elongated rod defining a rod engagement surface disposed within the rod housing, the rod engagement surface configured to be engageably coupled directly or indirectly to the worm gear. The magnetized linear actuator further comprises a plurality of magnets configured to control translation of the elongated rod between a retracted position and an extended position. The plurality of magnets are directly or indirectly mounted on at least one of the elongated rod and the rod housing. To be translated to the extended position from the retracted position, the rod is urged by a magnetic force of the plurality of magnets be in an engaged position in which the rod is engaged with the threaded surface of the worm gear, thereby causing or permitting the rod to translate in response to rotation of the worm gear along a first rotational direction, and the rod continues to translate until the rod is disengaged from the threaded surface and reaches the non-threaded surface of the worm gear. To be translated to the retracted position from the extended position, the rod is urged by the magnetic force of the plurality of magnets to return to the engaged position, thereby causing or permitting the rod to translate in response to rotation of the worm gear along a second rotational direction, and the rod continues to translate until the rod is disengaged from the threaded surface and reaches the non-threaded surface of the worm gear.

According to another aspect of the invention, an actuator assembly is disclosed. The actuator assembly comprises a latch and a magnetized linear actuator indirectly or directly coupled to the latch. The magnetized linear actuator includes a rod housing and a motor having a shaft. The magnetized linear actuator also includes a worm gear disposed within the rod housing and defining a threaded surface and a non-threaded surface. The worm gear is configured to be engageably coupled directly or indirectly to the shaft and the worm gear rotates about a rotation axis in response to motion of the shaft. The magnetized linear actuator also includes an elongated rod defining a rod engagement surface disposed within the rod housing, the rod engagement surface configured to be engageably coupled directly or indirectly to the worm gear. The magnetized linear actuator further comprises a plurality of magnets configured to control translation of the elongated rod between a retracted position and an extended position. The plurality of magnets are directly or indirectly mounted on at least one of the elongated rod and the rod housing. To be translated to the extended position from the retracted position, the rod is urged by a magnetic force of the plurality of magnets be in an engaged position in which the rod is engaged with the threaded surface of the worm gear, thereby causing or permitting the rod to translate in response to rotation of the worm gear along a first rotational direction, and the rod continues to translate until the rod is disengaged from the threaded surface and reaches the non-threaded surface of the worm gear. To be translated to the retracted position from the extended position, the rod is urged by the magnetic force of the plurality of magnets to return to the engaged position, thereby causing or permitting the rod to translate in response to rotation of the worm gear along a second rotational direction, and the rod continues to translate until the rod is disengaged from the threaded surface and reaches the non-threaded surface of the worm gear.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. Included in the drawings are the following figures:

FIG. 1A is a front perspective view depicting an embodiment of a magnetized linear actuator, showing an exemplary rod in a retracted position in accordance with aspects of the invention;

FIG. 1B is a top view depicting the magnetized linear actuator of FIG. 1A;

FIG. 1C is a side view depicting the magnetized linear actuator of FIG. 1A;

FIGS. 1D-1E are rear views depicting the magnetized linear actuator of FIG. 1A;

FIGS. 1F-1G are front views depicting the magnetized linear actuator of FIG. 1A;

FIG. 2A is a front perspective view of the magnetized linear actuator of FIG. 1A, showing the rod in an extended position in accordance with aspects of the invention;

FIG. 2B is a top view depicting the magnetized linear actuator of FIG. 2A;

FIG. 2C is a side view depicting the magnetized linear actuator of FIG. 2A;

FIGS. 3A-3B are cross-sectional views of the magnetized linear actuator of FIG. 1A;

FIGS. 4A-4B are cross-sectional views of the magnetized linear actuator of FIG. 2A;

FIG. 5 is perspective view of the magnetized linear actuator of FIG. 1A, with one or more components removed to show details of internal components;

FIG. 6A is a perspective view depicting the rod of the magnetized linear actuator of FIG. 1A;

FIG. 6B is a rear view depicting the rod of FIG. 6A;

FIG. 6C is a front view depicting the rod of FIG. 6A;

FIG. 6D is a top view depicting the rod of FIG. 6A;

FIG. 6E is a side view depicting the rod of FIG. 6A;

FIG. 7A is a perspective view depicting an exemplary worm gear of the magnetized linear actuator of FIG. 1A;

FIG. 7B is a rear view depicting the worm gear of FIG. 7A;

FIG. 7C is a front view depicting the worm gear of FIG. 7A;

FIG. 7D is a side view depicting the worm gear of FIG. 7A;

FIG. 8A is a front perspective view depicting an exemplary rod housing of the magnetized linear actuator of FIG. 1A;

FIG. 8B is a rear perspective view depicting the rod housing of FIG. 8A;

FIG. 8C is a side view depicting the rod housing of FIG. 8A;

FIG. 8D is a rear view depicting the rod housing of FIG. 8A;

FIG. 8E is a front view depicting the rod housing of FIG. 8A;

FIG. 9A is a front perspective view depicting an exemplary left motor housing of the magnetized linear actuator of FIG. 1A;

FIG. 9B is a rear view depicting the left motor housing of FIG. 9A;

FIG. 9C is a front view depicting the left motor housing of FIG. 9A;

FIG. 9D is a side view depicting the left motor housing of FIG. 9A;

FIG. 10A is a front perspective view depicting an exemplary right motor housing of the magnetized linear actuator of FIG. 1A;

FIG. 10B is a rear view depicting the right motor housing of FIG. 10A;

FIG. 10C is a front view depicting the right motor housing of FIG. 10A;

FIG. 10D is a side view depicting the right motor housing of FIG. 10A;

FIG. 11A is a front perspective view depicting an exemplary motor of the magnetized linear actuator of FIG. 1A;

FIG. 11B is a rear perspective view depicting the motor of FIG. 11A;

FIG. 11C is a side view depicting the motor of FIG. 11A;

FIG. 11D is a rear view depicting the motor of FIG. 11A;

FIG. 11E is a front view depicting the motor of FIG. 11A; and

FIGS. 12A-12G depict an embodiment of an actuator assembly having the magnetized linear actuator of FIG. 1A in accordance with aspects of the invention.

### DETAILED DESCRIPTION OF EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention. Furthermore, one of skill in the art would readily be able to utilize various aspects of the embodiments in different fields of endeavor.

Additionally, various forms and embodiments of the invention are illustrated in the figures. It will be appreciated that the combination and arrangement of some or all features of any of the embodiments with other embodiments is specifically contemplated herein. Accordingly, this detailed disclosure expressly includes the specific embodiments illustrated herein, combinations and sub-combinations of features of the illustrated embodiments, and variations of the illustrated embodiments.

Various terms are used throughout the disclosure to describe the physical shape or arrangement of features. A number of these terms are used to describe features that conform to a cylindrical or generally cylindrical geometry characterized by a radius and a center axis perpendicular to the radius. Unless a different meaning is specified, the terms are given the following meanings. The terms “longitudinal”, “longitudinally”, “axial” and “axially” refer to a direction, dimension or orientation that is parallel to a center axis. The terms “radial” and “radially” refer to a direction, dimension or orientation that is perpendicular to the center axis. The terms “inward” and “inwardly” refer to a direction, dimension or orientation that extends in a radial direction toward the center axis. The terms “outward” and “outwardly” refer to a direction, dimension or orientation that extends in a radial direction away from the center axis.

In the description, relative terms such as “left,” “right,” “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation.

Terms concerning attachments, coupling and the like, such as “mounted,” “connected” and “interconnected,” refer to a relationship wherein structures are secured or attached to one another either directly or indirectly through intervening structures, as well as both movable or rigid attachments or relationships, unless expressly described otherwise.

According to aspects of the invention, an electric linear actuator has a rod driven by a motor via a screw (e.g. lead screw, ball screw, roller screw, worm gear, etc.) and may include an internal gearbox. When power is applied to the linear actuator, the rod begins to translate, until the motor is deactivated (e.g. power is cut off). The power cut off signal typically comes from a limit switch, which thus controls the stroke (e.g. push/pull force and movement) of the rod by cutting off the power when the rod reaches a certain point. The polarity is then reversed, causing the rod to retract until it again receives a signal (e.g. from a limit switch) to stop.

Generally, embodiments of this invention also make it possible to eliminate need for limit switches used to signal travel stops for linear actuators and to prevent the rod from hitting a hard stop, thereby (1) decreasing wear on one or more components of the linear actuators, (2) decreasing risks to motor damage, and (3) using a lower power draw due to not stalling motor at end of travel. To achieve this, the exemplary linear actuator was designed to disengage the rod from the driven component (e.g. worm gear driven by the motor) at the end of the stroke or travel. To re-engage the rod with the driven component for additional translation (e.g. to return to a retracted or extended position), the exemplary linear actuator incorporated the use of magnets to urge the rod toward engagement with the worm gear, and thus move between retracted or extended positions). In this way, embodiments of a linear actuator as described herein can reduce the number of components, simplify overall design, and/or reduce costs related to maintenance or repair from wear and tear of one or more components of the linear actuators.

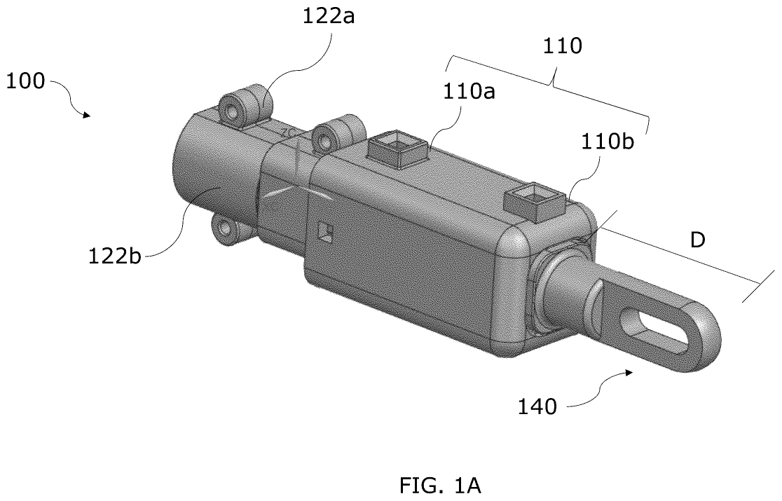

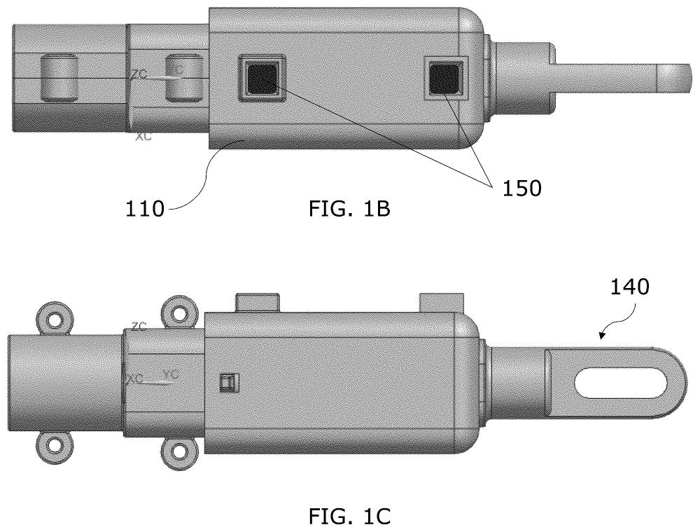

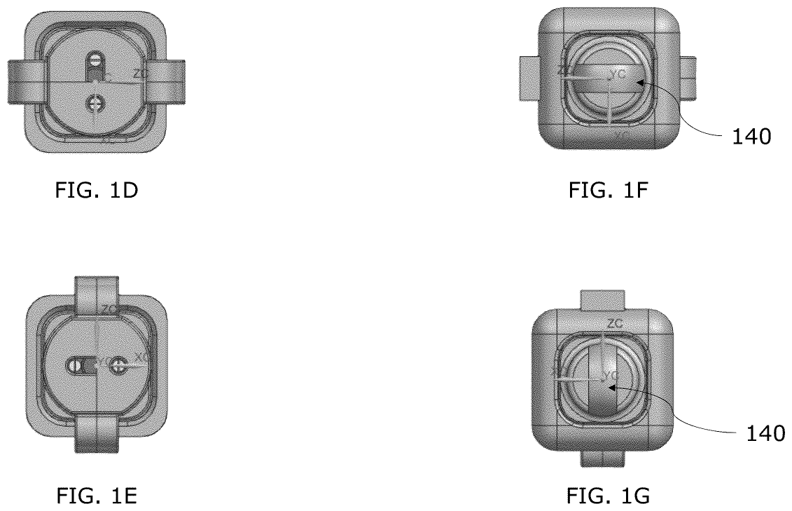

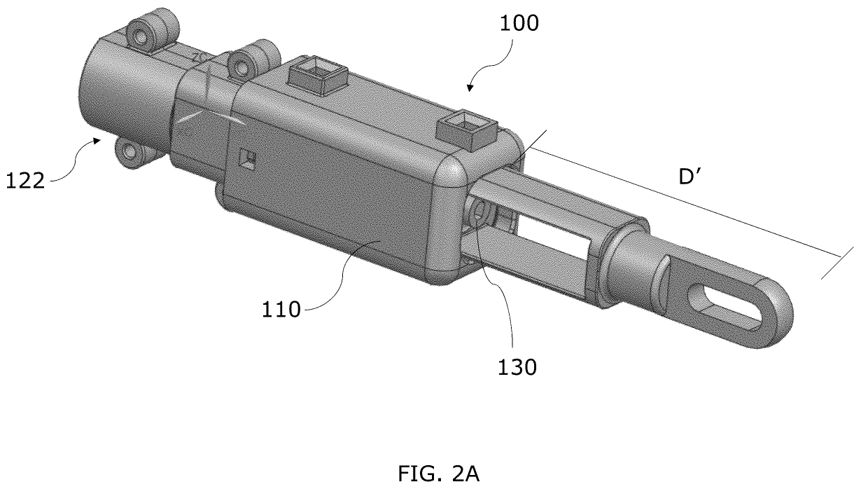

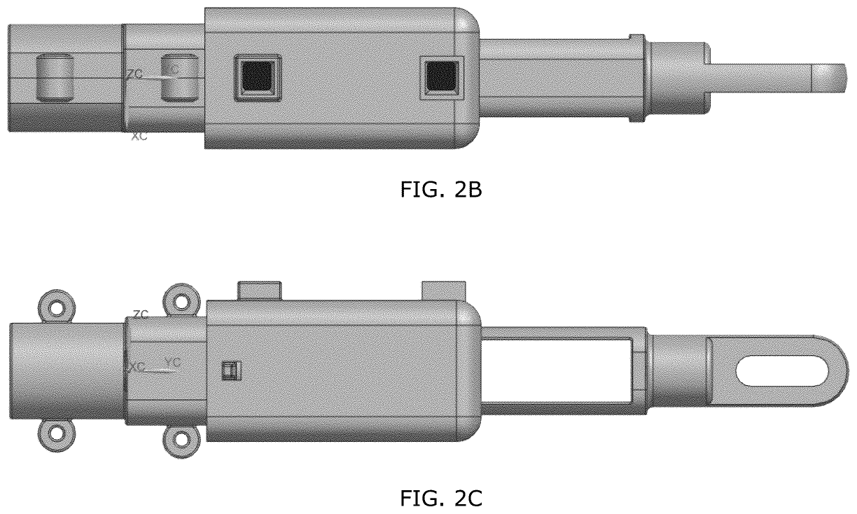

Referring now to the figures, FIGS. 1A-1G and 2A-2C depict an embodiment of a magnetized linear actuator in accordance with aspects of the invention. As a general overview, magnetized linear actuator 100 includes a rod housing 110, a motor 120, a worm gear 130, an elongated rod 140, and a plurality of magnets 150. Generally, one or more components of magnetized linear actuator 100 are affixed by way of well-known means, including welding, adhesives, riveting, or other fastening or affixing means. Yet, in a further embodiment, the one or more components of magnetized linear actuator 100 are combined to form one or more integral structures.

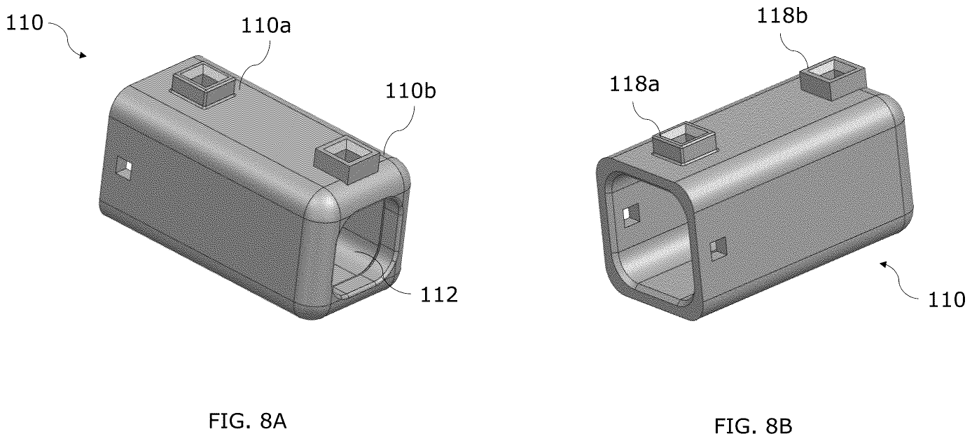

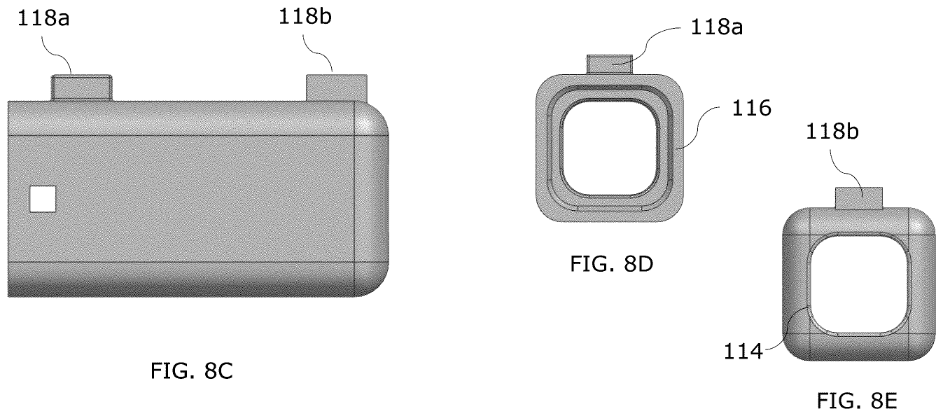

One or more components of the magnetized linear actuator 100 may be housed by a rod housing 110. In one non-limiting example, the rod housing 110 is configured to house at least the worm gear 130 and rod 140. In an exemplary embodiment, as shown in FIGS. 1A and 8A-8E, the rod housing 110 extends between a first (or proximal) section 110a and a second (or distal) section 110b. As illustrated in FIGS. 8A and 8B, rod housing 110 generally has a rectangular geometry showing a cavity 112 bounded by with regular borders, but one skilled in the art would appreciate from the description herein that rod housing 110 may have a geometry based on the size and shape of one or more components of the magnetized linear actuator 100, including but not limited to the worm gear 130 and rod 140. Although FIGS. 8A-8B illustrate that first section 110a defines an opening 114 and second section 110b defines another opening 116, wherein opening 116 has a diameter that is less than a diameter of the opening 114, one skilled in the art would understand from the description herein that the openings 114, and 116 may have a size and shape that are complementary to one or more components of the rod housing 110. Further, first section 110a and second section 110b are illustrates as being integrally formed as a unitary body, but in other embodiments, first section 110a and second section 110b may be separate components configured to be attached to one another by known attachment means (e.g. adhesives, fasteners, etc.). As best shown in FIGS. 8A-8E, first section 110a defines a proximal receptacle 118a and second section 110b defines a distal receptacle 118b. As will be discussed below, receptacles 118a, 118b are configured to receive and contain a respective one or more of the plurality of magnets 150. The geometry of receptacles 118a, 118b, as illustrated in FIGS. 8A-8E, are not intended to be limiting, and one skilled in the art would understand from the description herein that the respective one or more of the plurality of magnets 150 may be directly or indirectly positioned into receptacles 118a, 118b having complementary geometries.

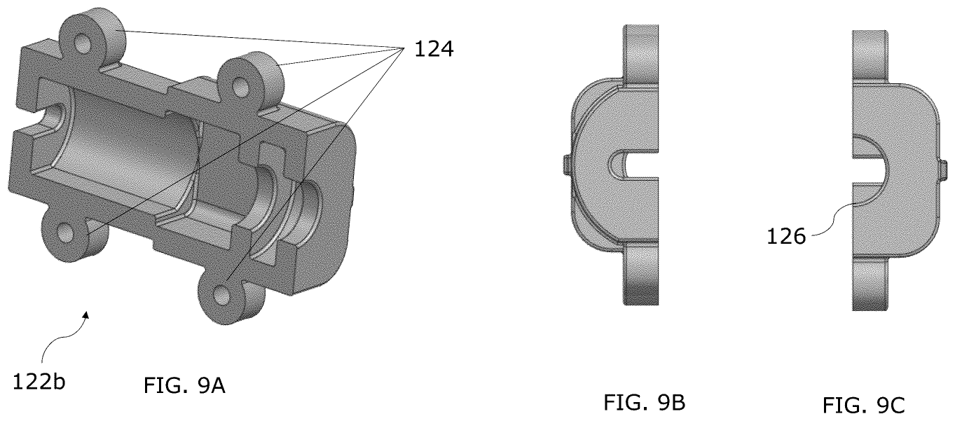

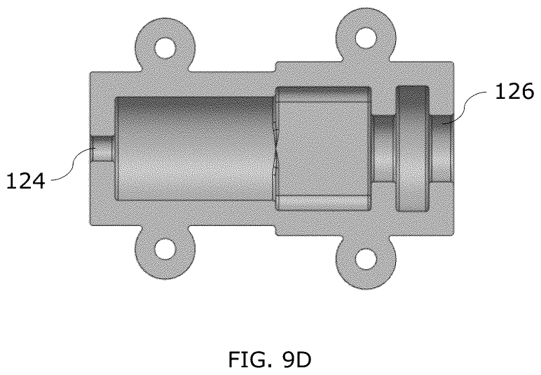

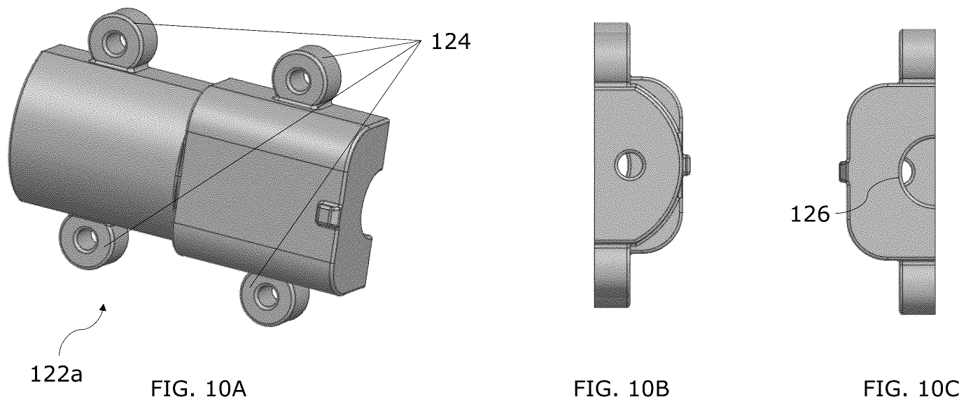

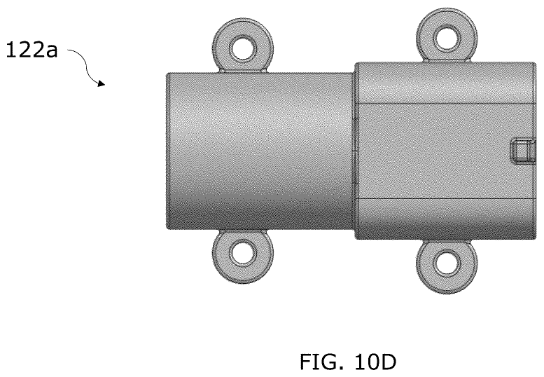

As shown on FIGS. 1A and 2A, positioned adjacent the first section 110a of the rod housing 110 is a motor housing 122 configured to enclose the motor 120 having a motor shaft 128. In an exemplary embodiment, the motor housing 122 can be formed from one or more structures which together define a cavity or space, with motor 120 being positionable within the space of the motor housing 122. Specifically, the motor housing 122 includes multiple structures which together define a cavity or space, including first housing portion 122a (e.g. left housing) and a second housing portion 122b (e.g. right housing), as shown in FIGS. 9A-9D and 10A-10D, respectively. Although the motor housing 122 is illustrated as being comprised of separate components, e.g. first housing portion 122a and a second housing portion 122b, one of ordinary skill in the art would understand from the description herein that the motor housing 122 may be integrally formed as a single body of unitary construction.

Additionally or optionally, attachment surfaces 124 may be formed at an outer periphery of motor housing 122 to provide means of attaching magnetized linear actuator 100 to one or more components of an actuator assembly (e.g. actuator assembly 1000 as discussed below).

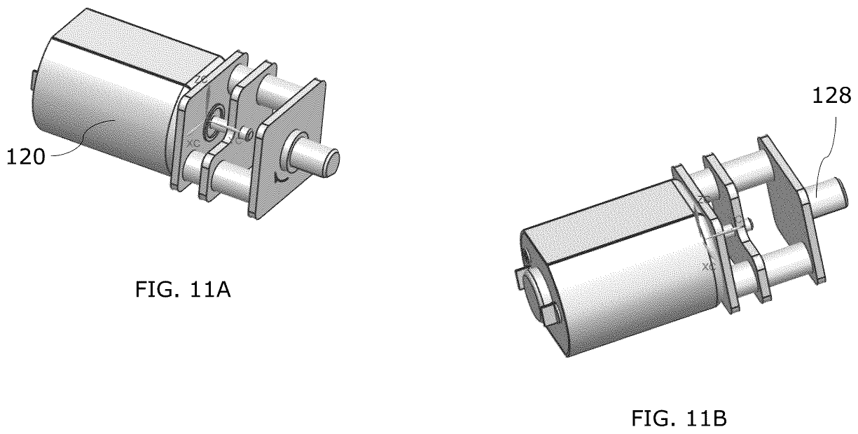

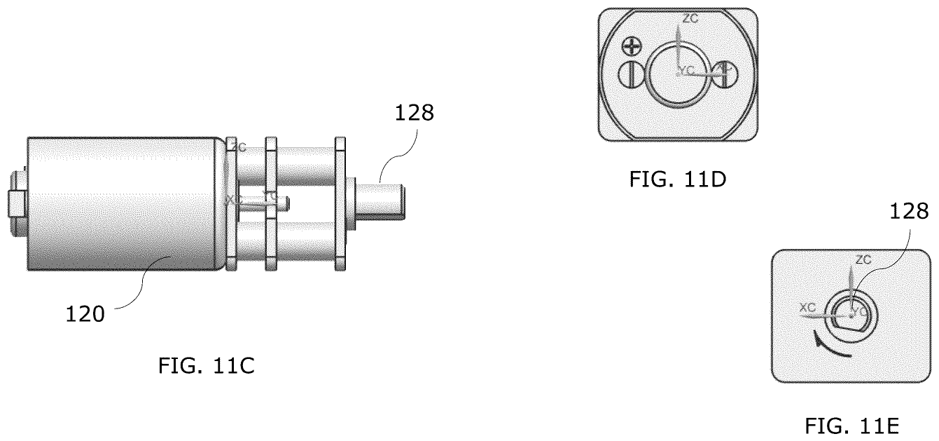

Referring now to FIGS. 9A-9D, 10A-10D, and 11A-11E, in an exemplary embodiment, the geometries of first housing portion 122a and a second housing portion 122b are complementary, such that together, a contoured surface corresponding to the motor 120 is secured within the space formed by motor housing 122. Additionally or optionally, an opening at one end of the motor housing 122 may be formed to facilitate connection of motor 120 to a power source (not shown). Another opening 126 at another end of the motor housing 122 is formed to facilitate passage of worm gear 130 to connect to at least a portion of motor shaft 128, which is positioned within the motor housing 122. Motor shaft 128 has a longitudinal axis. Various dimensions of the motor shaft 128, including non-uniform widths, lengths, cross-sectional shapes and circumferences, will be understood by one of skill in the art from the description herein.

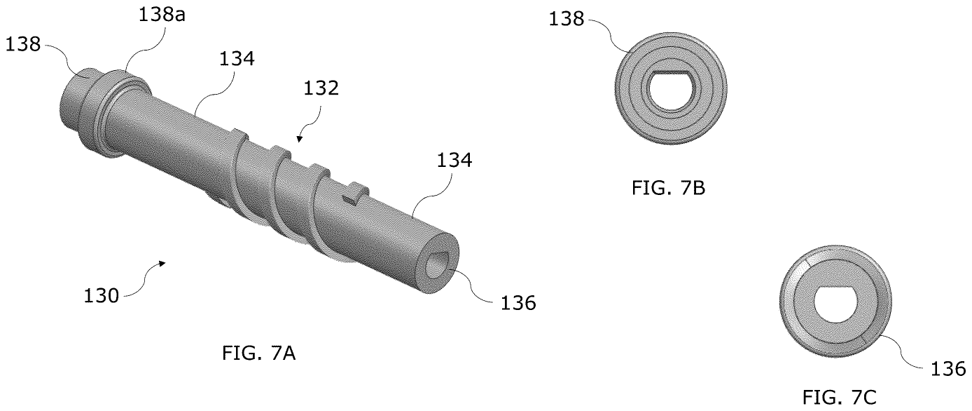

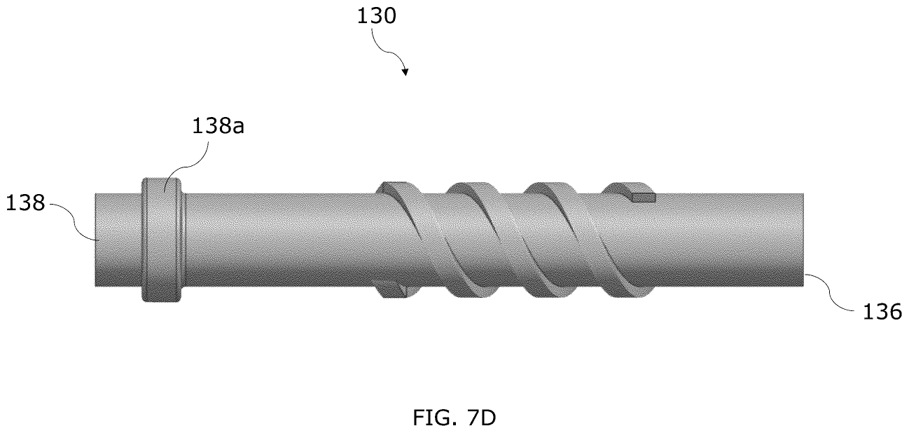

Turning now to FIGS. 7A-7D, a worm gear 130 is disposed within the rod housing 110. In an exemplary embodiment, worm gear 130 has a generally elongated body between a first (or distal) end portion 136 and a second (or proximal) end portion 138, which defines a longitudinal axis. In a non-limiting example, second end portion 138 includes a collar 138a. More particularly, second end portion 138 of the worm gear 130 is configured to be engageably coupled directly or indirectly to the shaft 128. In this configuration, the worm gear 130 rotates about a rotation axis in response to motion of the shaft 128. Additionally or optionally, worm gear 130 has a threaded surface 132 and a non-threaded surface 134, including a proximal non-threaded surface closest to the motor shaft 128 between the threaded surface 132 and the collar 138a, and a distal non-threaded surface farthest from the motor shaft 128 between the threaded surface 132 and the end of end portion 136. In a non-limiting example, as illustrated in FIGS. 7A-7D, the worm gear 130 has the threaded surface 132 along a middle portion of the body, with non-threaded surfaces 134 formed on either side of the threaded surface 132. The configuration of the threaded surface 132 and non-threaded surface 134 may depend, in part, on the desired characteristics of the travel of the rod 140 (discussed below) or the overall application of the magnetized linear actuator 100.

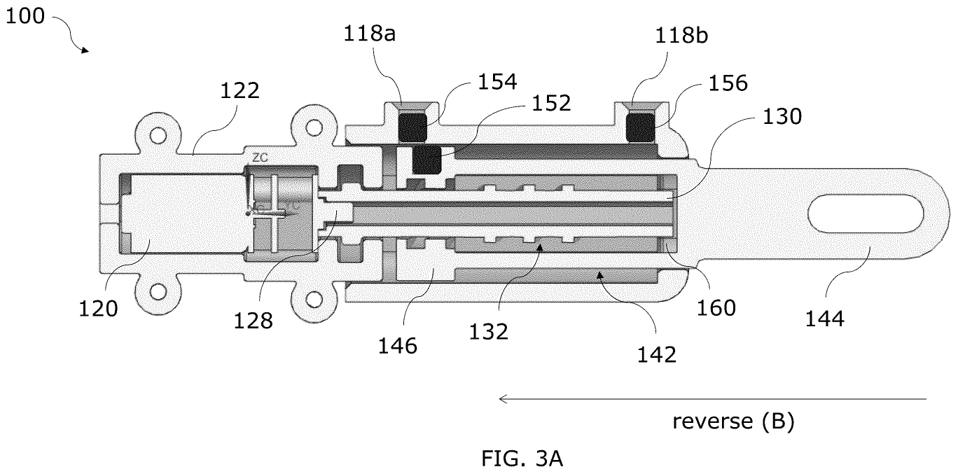

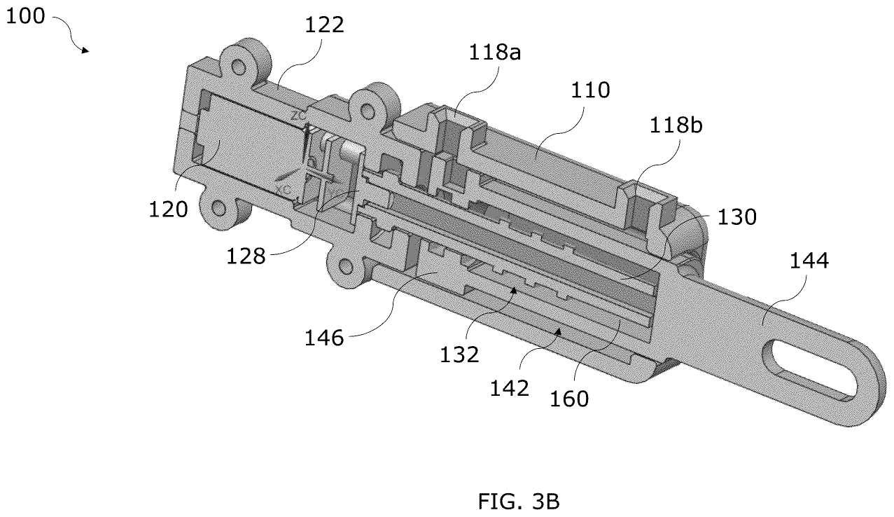

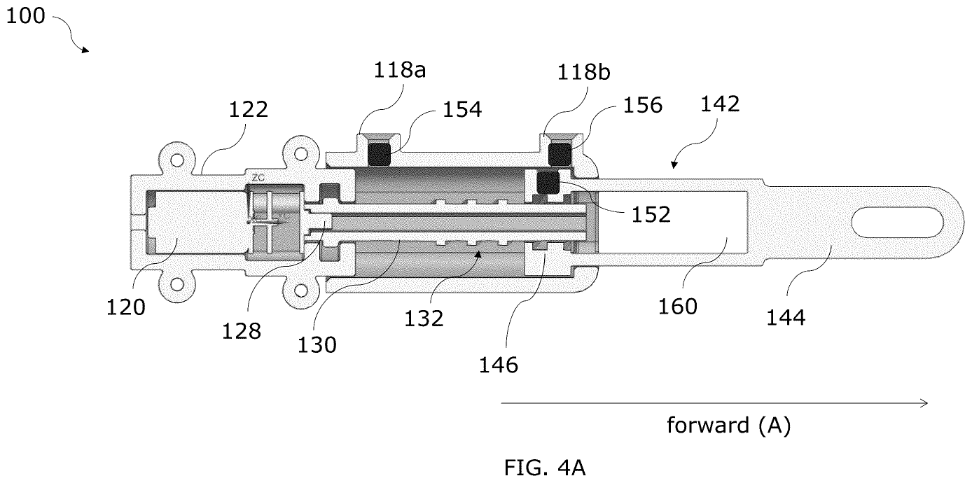

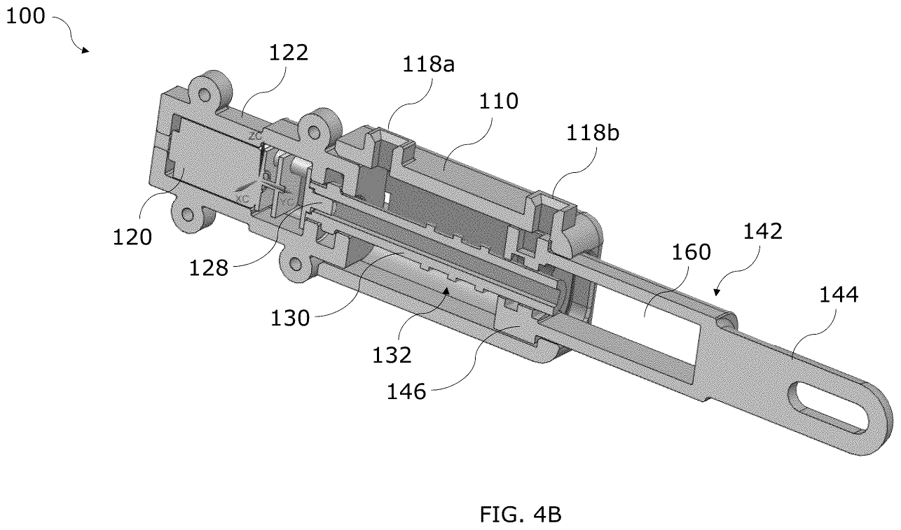

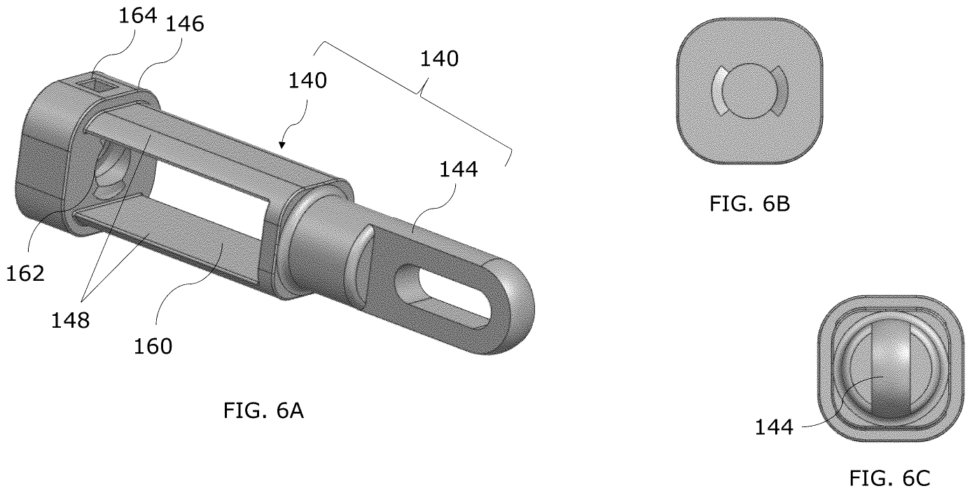

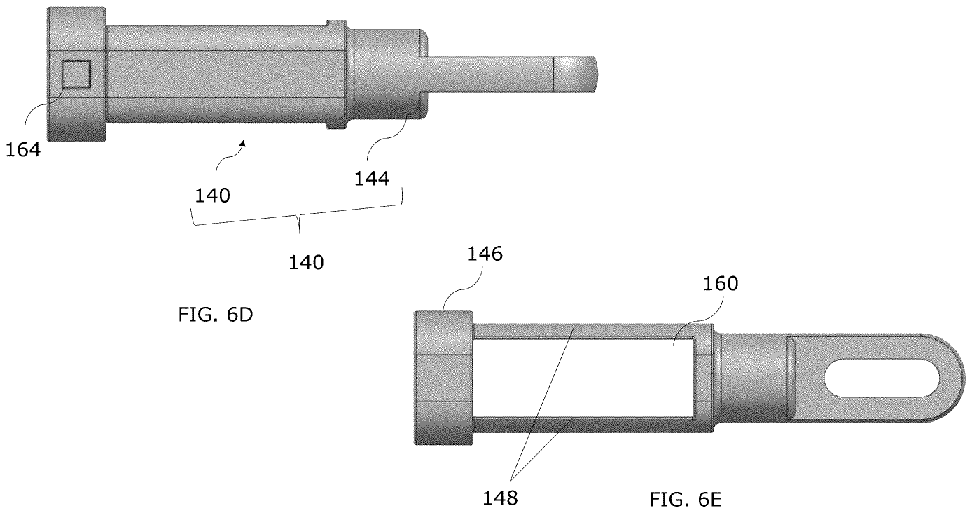

Turning now to FIGS. 6A-6E, in an exemplary embodiment, the elongated rod 140 has a rod engagement surface 142 disposed within the rod housing 110, and an arm 144 extending outside the rod housing 110. Although the rod 140 is illustrated as being integrally formed as a single body of unitary construction, one of ordinary skill in the art would understand from the description herein that rod 140 may be comprised of separate components, e.g. rod engagement surface 142 and arm 144. In an exemplary embodiment, rod engagement surface 142 comprises a base 146 with prongs 148 extending therefrom, such that a space 160 is formed between prongs 148. In this configuration, the rod engagement surface 142 is biased to be positioned radially outward relative to the rotation axis of the worm gear 130 when traveling between a retracted position, such as a proximal position relative to the motor 120, and an extended position, such as a distal position relative to the motor 120. Additionally or optionally, pace 160 may facilitate passage of worm gear 130 therethrough, as best illustrated in cross-sectional views of FIGS. 3A-3B and 4A-4B, and thus convert rotational motion of worm gear to translational motion of rod 140 relative to rod housing 110. To achieve this, the rod engagement surface 140 is configured to be engageably coupled directly or indirectly to the worm gear 130. Additionally or optionally, base 146 defines an opening 162 through which worm gear 130 extends. Similar to the rod housing 110, base 146 defines a receptacle 164 configured to receive and contain a respective one or more of the plurality of magnets 150. The geometry of receptacle 164, as illustrated in FIGS. 6A-6E, are not intended to be limiting, and one skilled in the art would understand from the description herein that the respective one or more of the plurality of magnets 150 may be directly or indirectly positioned into receptacle 164 having complementary geometries.

The functionality of the aforementioned features will now be discussed in more detail below. Embodiments of the present invention make it possible to eliminate need for limit switches used to signal travel stops for linear actuators and to prevent the rod from hitting a hard stop, thereby (1) decreasing wear on one or more components of the linear actuators, (2) decreasing risks to motor damage, and (3) using a lower power draw due to not stalling motor at end of travel.

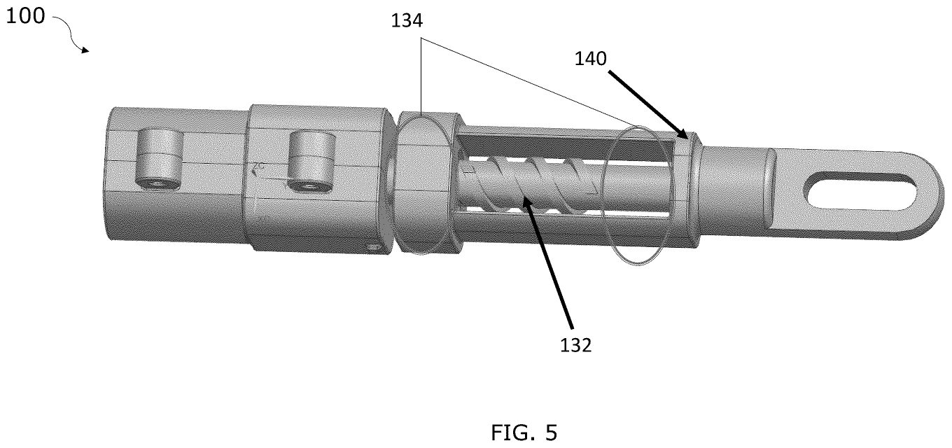

In an exemplary embodiment, and with reference to FIGS. 5, 3A-3B (when rod 140 is in the retracted position), and 4A-4B (when rod 140 is in the extended position), when the motor 120 is activated and motor shaft 128 rotates, worm gear 130 rotates in response to motion of the motor shaft 128. As the worm gear rotates, at least the rod engagement surface 142, which is configured to be engageably coupled directly or indirectly to the worm gear 130, translates. In an exemplary embodiment, the plurality of magnets 150 is configured to control translation of the elongated rod 140 between the retracted position and the extended position. To achieve this, as best shown in FIGS. 3A and 4A, a plurality of magnets 150 are configured to be directly or indirectly mounted on at least one of the elongated rod 140 and the rod housing 110. In an exemplary embodiment, the plurality of magnets 150 comprises a rod magnet 152. Rod magnet 152 is configured to be received by a receptacle, such as receptacle 164. Correspondingly, the plurality of magnets 150 comprises a first (or proximal) rod housing magnet 154 and a second (or distal) rod housing magnet 156. The first rod housing magnet 154 is configured to be received by a receptacle, such as receptacle 118a, and second rod housing magnet 156 is configured to be received by a receptacle, such as receptacle 118b. In this configuration, the first rod housing magnet 154 and the rod magnet 152 are arranged with alternating polarities. Additionally or optionally, the second rod housing magnet 156 and the rod magnet 152 are arranged with alternating polarities.

As shown in FIGS. 4A-4B, to be translated to the extended position from the retracted position, the rod 140 translates in response to rotation of the worm gear 130 along a first rotational direction (e.g. counterclockwise or clockwise). In a non-limiting example, the motor 120 is configured to rotate the shaft 128 in the first rotational direction to cause the worm gear 130 to rotate in the first rotational direction, thereby permitting or causing movement of the rod 140 toward the extended position.

In an exemplary embodiment, to be translated to the extended position from the retracted position, the rod 140 is urged by a magnetic force of the plurality of magnets 150 to be in an engaged position. When the rod 140 is in the engaged position, the rod engagement surface 142 is engaged with the threaded surface 132 of the worm gear 130. In this way, when the rod engagement surface 142 is engaged with the threaded surface 132, the rod is caused or permitted to translate (e.g. along a direction of arrow “A” as depicted in FIG. 4A) in response to rotation of the worm gear 130 along a first rotational direction (e.g. clockwise or counterclockwise). The rod 130 continues to translate until the rod 140 (e.g. rod engagement surface 142) is disengaged from the threaded surface 132 and reaches the distal non-threaded surface 134 of the worm gear 130.

Additionally or optionally, the rod 140 translates in response to rotation of the worm gear 130 along the first rotational direction, until the rod 140 reaches the non-threaded surface 134 of the worm gear 130. In an exemplary embodiment, the rod 140 is a distance (D′) away from second section 110b of the rod housing 110 at the extended position, as shown in FIG. 2A. When the rod 140 reaches the non-threaded surface 134 of the worm gear 130, and the second rod housing magnet 156 and the rod magnet 152 are arranged with alternating polarities, the rod 140 is urged to return to the engaged position (in which the rod 140 is engaged with the threaded surface 132 of the worm gear 130) by the magnetic force resulting from second rod housing magnet 156 and the rod magnet 152 repelling each other. Thus, to be translated to the retracted position from the extended position, the plurality of magnets 150 permits the rod 140 to re-engage with the threaded surface 132 of the worm gear 130.

Additionally or optionally, the magnetic force applied by the plurality of magnets 150 is configured to restrict or resist additional movement of the rod 140 beyond the extended position. In an exemplary embodiment, the second rod housing magnet 156 and the rod magnet 152 exert a magnetic force that restricts or resists movement (e.g. translation) of the rod 140 to move in the direction of arrow “A” (as depicted in FIG. 4A).

Conversely, as shown in FIGS. 3A-3B, to be translated to the retracted position from the extended position, the rod 140 translates in response to rotation of the worm gear 130 along a second rotational direction (e.g. counterclockwise or clockwise). In a non-limiting example, the motor 120 is configured to rotate the shaft 128 in the second rotational direction to cause the worm gear 130 to rotate in the second rotational direction, thereby permitting or causing movement of the rod 140 toward the retracted position. In an exemplary embodiment, the second rotational direction is different from the first rotational direction. In an exemplary embodiment, the rod 140 is a distance (D) away from second section 110b of the rod housing 110 at the retracted position, as shown in FIG. 1A.

In an exemplary embodiment, to be translated to the retracted position from the extended position, the rod 140 is urged by the magnetic force of the plurality of magnets 150 to be in an engaged position. When the rod 140 is in the engaged position, the rod engagement surface 142 is engaged with the threaded surface 132 of the worm gear 130. In this way, when the rod engagement surface 142 is engaged with the threaded surface 132, the rod is caused or permitted to translate (e.g. along a direction of arrow “B” as depicted in FIG. 3A) in response to rotation of the worm gear 130 along a second rotational direction (e.g. clockwise or counterclockwise). The rod 130 continues to translate until the rod 140 (e.g. rod engagement surface 142) is disengaged from the threaded surface 132 and reaches the proximal non-threaded surface 134 of the worm gear 130.

Additionally or optionally, when the rod 140 reaches the proximal non-threaded surface 134 of the worm gear 130, and the second rod housing magnet 156 and the rod magnet 152 are arranged with alternating polarities, the rod 140 is urged to return to the engaged position (in which the rod 140 is engaged with the threaded surface 132 of the worm gear 130) by the magnetic force resulting from the first rod housing magnet 154 and the rod magnet 152 repelling each other. Thus, to be translated to the extended position from the retracted position, the plurality of magnets 150 permits the rod 140 to re-engage with the threaded surface 132 of the worm gear 130.

Additionally or optionally, the magnetic force applied by the plurality of magnets 150 is configured to restrict or resist additional movement of the rod 140 beyond the retracted position. In an exemplary embodiment, the first rod housing magnet 154 and the rod magnet 152 exert a magnetic force that restricts or resists movement (e.g. translation) of the rod 140 to move in the direction of arrow “B” (as depicted in FIG. 3A).

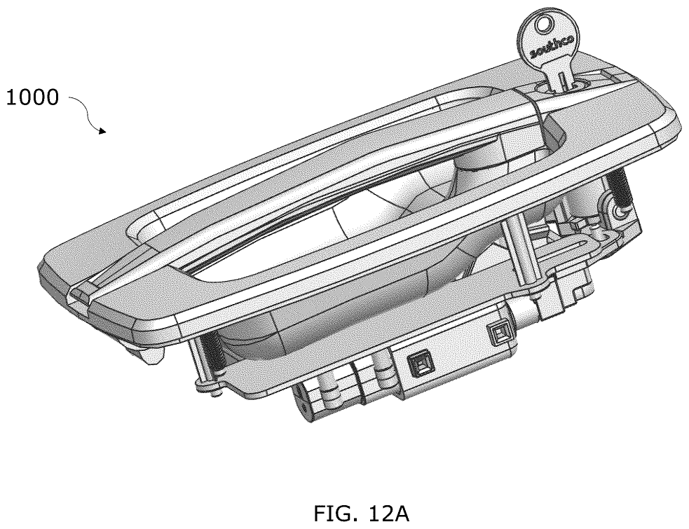

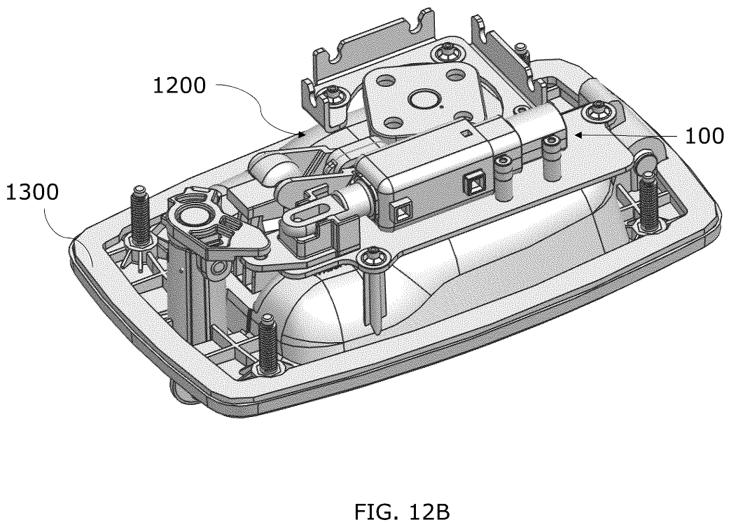

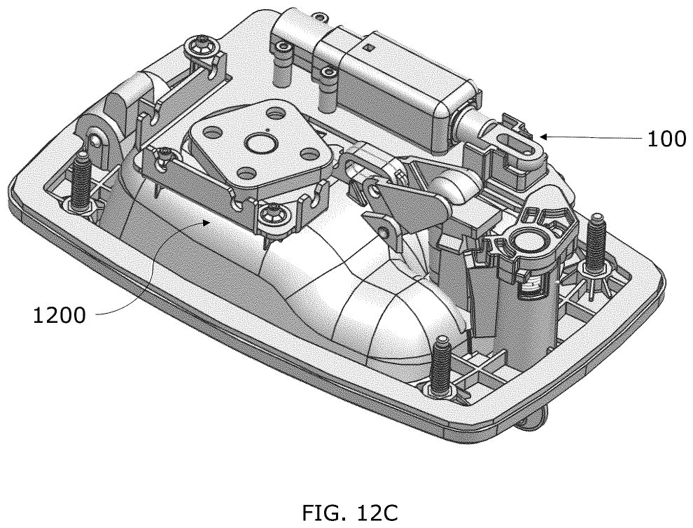

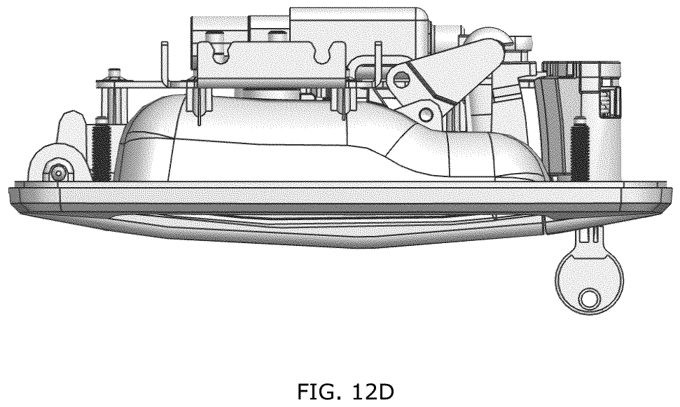

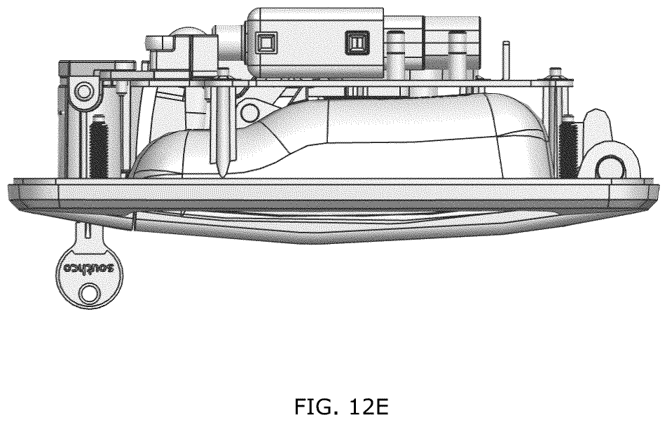

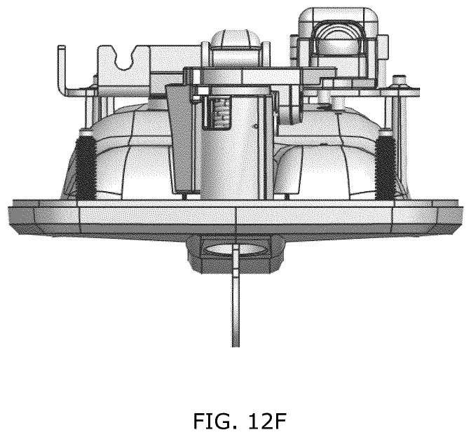

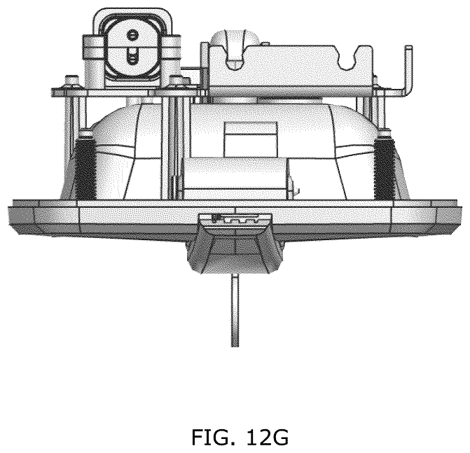

Assemblies and/or systems employing embodiments of the present invention include actuator assemblies. In an exemplary embodiment, actuator assembly 1000 may also be equipped with a latching mechanism, such as latch 1200, as shown in FIGS. 12A-12G. FIGS. 12A-12G depict views of an embodiment of actuator assembly 1000 in accordance with aspects of the invention. In this embodiment, a component 1300 (e.g. a movable door or panel) is provided. In a non-limiting example, mounted on component 1300 is a linear actuator, such as magnetized linear actuator 100. In an exemplary embodiment, also mounted on component 1300 is latch 1200, which is directly or indirectly coupled to the magnetized linear actuator 100. In this way, operation of magnetized linear actuator 100 may facilitate movement of latch 1200 between a latched position in which access to the interior is restricted or prevented and an unlatched position in which access to the interior is permitted. In an exemplary embodiment, as illustrated in FIGS. 12A-12G, magnetized linear actuator 100 moves a mechanical lock plug from the locked to unlocked position, thereby allowing the latch 1200 to move between latched and unlatched states, respectively.

Although discussed in relation to latches, one skilled in the art would understand from the description herein that the application of magnetized linear actuator 100 is not limited to latches, but other applications may be readily apparent and within the spirit and scope of this invention. For example, magnetized linear actuator 100 may be used to facilitate movement (e.g. lifted, lowered, pushed, pulled, positioned, etc.) of an object or equipment. In an exemplary embodiment, magnetized linear actuator 100 may be used to moved cable systems, means for position control, or systems requiring linear motion and/or rotational motion.

Still further, although discussed in relation to magnets, one skilled in the art would understand from the description herein that the application of linear actuator 100 is not limited to use of magnets to facilitate re-engagement of rod 140 with the worm gear 130 (e.g. threaded surface 132 of worm gear 130). Other biasing means, such as a spring, may be incorporated as additional or alternative methods of biasing the rod 140 toward an engaged or disengaged position relative to the worm gear 130. Also, although embodiments are illustrated with the proximal housing magnet 154 and the distal housing magnet 156, it is contemplated that the system may include only one of the proximal housing magnet 154 or the distal housing magnet 156. For example, worm gear 130 may only have a distal non-threaded surface 134 and the housing may only engage a distal housing magnet 156 to urge the rod 140 in a proximal direction to re-engage the threaded surface 132 of the worn gear 130.

Conversely, worm gear 130 may only have a proximal non-threaded surface 134 and the housing may only engage a proximal housing magnet 156 to urge the rod 140 in a distal direction to re-engage the threaded surface 132 of the worn gear 130.

This invention includes, but is not limited to, the following aspects:
1. A magnetized linear actuator comprising:
   a rod housing;
   a motor having a shaft;
   a worm gear disposed at least partially within the rod housing and defining a threaded surface and proximal and distal non-threaded surfaces, the worm gear being configured to be engageably coupled directly or indirectly to the shaft of the motor and the worm gear rotates about a rotation axis in response to motion of the shaft;
   an elongated rod defining a rod engagement surface disposed within the rod housing, the rod engagement surface configured to be engageably coupled directly or indirectly to the worm gear, and the elongated rod being mounted for movement between a retracted position and an extended position relative to the rod housing; and
   a plurality of magnets directly or indirectly mounted on at least one of the elongated rod and the rod housing;
   wherein to be translated to the extended position from the retracted position, the rod is urged by a magnetic force of the plurality of magnets to be in an engaged position in which the rod is engaged with the threaded surface of the worm gear, thereby causing or permitting the rod to translate in response to rotation of the worm gear along a first rotational direction, and the rod continues to translate until the rod is disengaged from the threaded surface and reaches the distal non-threaded surface of the worm gear; and
   wherein to be translated to the retracted position from the extended position, the rod is urged by the magnetic force of the plurality of magnets to return toward the engaged position, thereby causing or permitting the rod to translate in response to rotation of the worm gear along a second rotational direction, and the rod continues to translate until the rod is disengaged from the threaded surface and reaches the proximal non-threaded surface of the worm gear.
2. The magnetized linear actuator of aspect 1, wherein the plurality of magnets comprises a rod magnet, and the rod engagement surface defines a first receptacle configured to receive the rod magnet.
3. The magnetized linear actuator of aspect 2, wherein the plurality of magnets comprises a first rod housing magnet and a second rod housing magnet, and the rod housing defines a second receptacle configured to receive the first rod housing magnet and a third receptacle spaced apart from the second receptacle and configured to receive the second rod housing magnet.
4. The magnetized linear actuator of aspect 3, wherein the first rod housing magnet and the rod magnet are arranged with alternating polarities, and wherein the second rod housing magnet and the rod magnet are arranged with alternating polarities.
5. The magnetized linear actuator of aspect 4, wherein the rod housing comprises a first section adjacent to the motor and the rod housing comprises a second section opposite the first section.
6. The magnetized linear actuator of aspect 5, wherein the second receptacle is located in the first section and the third receptacle is located in the second section.
7. The magnetized linear actuator of aspect 6, wherein to be translated to the extended position from the retracted position, the rod translates in response to rotation of the worm gear along the first rotational direction, until the rod reaches the distal non-threaded surface of the worm gear and the rod is urged by the magnetic force between the rod magnet and the second rod housing magnet to restrict or resist additional movement of the rod relative to the rod housing beyond the extended position.
8. The magnetized linear actuator of aspect 7, wherein to be translated to the retracted position from the extended position, the rod translates in response to rotation of the worm gear along the second rotational direction, until the rod is urged by the magnetic force between the rod magnet and the first rod housing magnet to restrict or resist additional movement of the rod relative to the rod housing beyond the retracted position.
9. The magnetized linear actuator of aspect 8, wherein the motor is configured to rotate the shaft in the first rotational direction to cause the worm gear to rotate in the first rotational direction, thereby permitting or causing movement of the rod toward the extended position.
10. The magnetized linear actuator of aspect 9, wherein the motor is configured to rotate the shaft in the second rotational direction to cause the worm gear to rotate in the second rotational direction, thereby permitting or causing movement of the rod toward the retracted position.
11. The magnetized linear actuator of aspect 10, wherein the second rotational direction is opposite the first rotational direction.
12. The magnetized linear actuator of aspect 1, wherein the rod engagement surface is biased to be positioned radially outward relative to the rotation axis of the worm gear when traveling between the retracted position and the extended position.
13. The magnetized linear actuator of aspect 1, wherein the elongated rod comprises an arm coupled to the engagement surface, and wherein at least the arm extends outside the rod housing.
14. The magnetized linear actuator of aspect 1, further comprising a motor housing configured to house the motor, the motor housing being coupled to the rod housing.
15. An actuator assembly comprising:
   a latch;
   a magnetized linear actuator directly or indirectly coupled to the latch, the magnetized linear actuator including:
      a rod housing,
      a motor having a shaft,
      a worm gear disposed at least partially within the rod housing and defining a threaded surface and proximal and distal non-threaded surfaces, the worm gear being configured to be engageably coupled directly or indirectly to the shaft of the motor and the worm gear rotates about a rotation axis in response to motion of the shaft,
      an elongated rod defining a rod engagement surface disposed within the rod housing, the rod engagement surface configured to be engageably coupled directly or indirectly to the worm gear, and the elongated rod being mounted for movement between a retracted position and an extended position relative to the rod housing,
      a plurality of magnets directly or indirectly mounted on at least one of the elongated rod and the rod housing,
      wherein to be translated to the extended position from the retracted position, the rod is urged by a magnetic force of the plurality of magnets be in an engaged position in which the rod is engaged with the threaded surface of the worm gear, thereby causing or permitting the rod to translate in response to rotation of the worm gear along a first rotational direction, and the rod continues to translate until the rod is disengaged from the threaded surface and reaches the distal non-threaded surface of the worm gear; and
      wherein to be translated to the retracted position from the extended position, the rod is urged by the magnetic force of the plurality of magnets to return to the engaged position, thereby causing or permitting the rod to translate in response to rotation of the worm gear along a second rotational direction, and the rod continues to translate until the rod is disengaged from the threaded surface and reaches the proximal non-threaded surface of the worm gear.
16. The actuator assembly of aspect 15, wherein to be translated to the extended position from the retracted position, the rod translates in response to rotation of the worm gear along the first rotational direction, until the rod reaches the distal non-threaded surface of the worm gear and the rod is urged by the magnetic force between the rod magnet and the second rod housing magnet to restrict or resist additional movement of the rod relative to the rod housing beyond the extended position
17. The actuator assembly of aspect 15, wherein to be translated to the retracted position from the extended position, the rod translates in response to rotation of the worm gear along the second rotational direction, until the rod is urged by the magnetic force between the rod magnet and the first rod housing magnet to restrict or resist additional movement of the rod relative to the rod housing beyond the retracted position.
18. The actuator assembly of aspect 15, the latch being a compression latch, a rotary latch, a pull latch, or an electro-mechanical latch.
   While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A magnetized linear actuator comprising:
a rod housing;
a motor having a shaft;
a worm gear disposed at least partially within the rod housing and defining a threaded surface and proximal and distal non-threaded surfaces, the worm gear being configured to be engageably coupled directly or indirectly to the shaft of the motor and the worm gear rotates about a rotation axis in response to motion of the shaft;
an elongated rod defining a rod engagement surface disposed within the rod housing, the rod engagement surface configured to be engageably coupled directly or indirectly to the worm gear, and the elongated rod being mounted for movement between a retracted position and an extended position relative to the rod housing; and
a plurality of magnets directly or indirectly mounted on at least one of the elongated rod and the rod housing;
wherein to be translated to the extended position from the retracted position, the rod is urged by a magnetic force of the plurality of magnets to be in an engaged position in which the rod is engaged with the threaded surface of the worm gear, thereby causing or permitting the rod to translate in response to rotation of the worm gear along a first rotational direction, and the rod continues to translate until the rod is disengaged from the threaded surface and reaches the distal non-threaded surface of the worm gear; and
wherein to be translated to the retracted position from the extended position, the rod is urged by the magnetic force of the plurality of magnets to return toward the engaged position, thereby causing or permitting the rod to translate in response to rotation of the worm gear along a second rotational direction, and the rod continues to translate until the rod is disengaged from the threaded surface and reaches the proximal non-threaded surface of the worm gear.

2. The magnetized linear actuator of claim 1, wherein the plurality of magnets comprises a rod magnet, and the rod engagement surface defines a first receptacle configured to receive the rod magnet.

3. The magnetized linear actuator of claim 2, wherein the plurality of magnets comprises a first rod housing magnet and a second rod housing magnet, and the rod housing defines a second receptacle configured to receive the first rod housing magnet and a third receptacle spaced apart from the second receptacle and configured to receive the second rod housing magnet.

4. The magnetized linear actuator of claim 3, wherein the first rod housing magnet and the rod magnet are arranged with alternating polarities, and wherein the second rod housing magnet and the rod magnet are arranged with alternating polarities.

5. The magnetized linear actuator of claim 4, wherein the rod housing comprises a first section adjacent to the motor and the rod housing comprises a second section opposite the first section.

6. The magnetized linear actuator of claim 5, wherein the second receptacle is located in the first section and the third receptacle is located in the second section.

7. The magnetized linear actuator of claim 6, wherein to be translated to the extended position from the retracted position, the rod translates in response to rotation of the worm gear along the first rotational direction, until the rod reaches the distal non-threaded surface of the worm gear and the rod is urged by the magnetic force between the rod magnet and the second rod housing magnet to restrict or resist additional movement of the rod relative to the rod housing beyond the extended position.

8. The magnetized linear actuator of claim 7, wherein to be translated to the retracted position from the extended position, the rod translates in response to rotation of the worm gear along the second rotational direction, until the rod is urged by the magnetic force between the rod magnet and the first rod housing magnet to restrict or resist additional movement of the rod relative to the rod housing beyond the retracted position.

9. The magnetized linear actuator of claim 8, wherein the motor is configured to rotate the shaft in the first rotational direction to cause the worm gear to rotate in the first rotational direction, thereby permitting or causing movement of the rod toward the extended position.

10. The magnetized linear actuator of claim 9, wherein the motor is configured to rotate the shaft in the second rotational direction to cause the worm gear to rotate in the second rotational direction, thereby permitting or causing movement of the rod toward the retracted position.

11. The magnetized linear actuator of claim 10, wherein the second rotational direction is opposite the first rotational direction.

12. The magnetized linear actuator of claim 1, wherein the rod engagement surface is biased to be positioned radially outward relative to the rotation axis of the worm gear when traveling between the retracted position and the extended position.

13. The magnetized linear actuator of claim 1, wherein the elongated rod comprises an arm coupled to the engagement surface, and wherein at least the arm extends outside the rod housing.

14. The magnetized linear actuator of claim 1, further comprising a motor housing configured to house the motor, the motor housing being coupled to the rod housing.

15. An actuator assembly comprising:
a latch;
a magnetized linear actuator directly or indirectly coupled to the latch, the magnetized linear actuator including:
a rod housing, a motor having a shaft, a worm gear disposed at least partially within the rod housing and defining a threaded surface and proximal and distal non-threaded surfaces, the worm gear being configured to be engageably coupled directly or indirectly to the shaft of the motor and the worm gear rotates about a rotation axis in response to motion of the shaft, an elongated rod defining a rod engagement surface disposed within the rod housing, the rod engagement surface configured to be engageably coupled directly or indirectly to the worm gear, and the elongated rod being mounted for movement between a retracted position and an extended position relative to the rod housing, a plurality of magnets directly or indirectly mounted on at least one of the elongated rod and the rod housing, wherein to be translated to the extended position from the retracted position, the rod is urged by a magnetic force of the plurality of magnets be in an engaged position in which the rod is engaged with the threaded surface of the worm gear, thereby causing or permitting the rod to translate in response to rotation of the worm gear along a first rotational direction, and the rod continues to translate until the rod is disengaged from the threaded surface and reaches the distal non-threaded surface of the worm gear; and
wherein to be translated to the retracted position from the extended position, the rod is urged by the magnetic force of the plurality of magnets to return to the engaged position, thereby causing or permitting the rod to translate in response to rotation of the worm gear along a second rotational direction, and the rod continues to translate until the rod is disengaged from the threaded surface and reaches the proximal non-threaded surface of the worm gear.

16. The actuator assembly of claim 15, wherein to be translated to the extended position from the retracted position, the rod translates in response to rotation of the worm gear along the first rotational direction, until the rod reaches the distal non-threaded surface of the worm gear and the rod is urged by the magnetic force between the rod magnet and the second rod housing magnet to restrict or resist additional movement of the rod relative to the rod housing beyond the extended position

17. The actuator assembly of claim 15, wherein to be translated to the retracted position from the extended position, the rod translates in response to rotation of the worm gear along the second rotational direction, until the rod is urged by the magnetic force between the rod magnet and the first rod housing magnet to restrict or resist additional movement of the rod relative to the rod housing beyond the retracted position.

18. £ The actuator assembly of claim 15, the latch being a compression latch, a rotary latch, a pull latch, or an electro-mechanical latch.
